(19) United States
(12) Patent Application Publication
(10) Pub. No.: US 2023/0392015 A1
(43) Pub. Date: Dec. 7, 2023

(54) HIGH-MODULUS ASPHALT BINDER AND MIXTURE, AND PREPARATION METHOD FOR HIGH-MODULUS ASPHALT BINDER

(71) Applicants: XI'AN ZHONGLI ASPHALT CO., LTD., Xi'an (CN); XI'AN LUCHANGTONG TRANSPORTATION TECHNOLOGY DEVELOPMENT CO., LTD, Xi'an (CN)

(72) Inventors: Yun ZENG, Xi'an (CN); Ling ZHANG, Xi'an (CN); Xiaoli JI, Xi'an (CN); Qiaoning ZHANG, Xi'an (CN); Ziyang ZHANG, Xi'an (CN); Quanwen ZHAO, Xi'an (CN); Xiaodong HAN, Xi'an (CN); Xiaohong ZHANG, Xi'an (CN)

(73) Assignees: XI'AN ZHONGLI ASPHALT CO., LTD., Xi'an (CN); XI'AN LUCHANGTONG TRANSPORTATION TECHNOLOGY DEVELOPMENT CO., LTD, Xi'an (CN)

(21) Appl. No.: 18/453,309

(22) Filed: Aug. 21, 2023

Related U.S. Application Data
(63) Continuation of application No. PCT/CN2021/077523, filed on Feb. 23, 2021.

(51) Int. Cl. C08L 95/00; C08J 3/00

(52) U.S. Cl. CPC C08L 95/00; C08J 3/005; C08L 2555/84; C08J 2395/00; C08J 2409/06

(57) ABSTRACT

A high-modulus asphalt binder of the present application includes 100 parts by weight of asphalt consisting of natural asphalt and petroleum asphalt in a weight ratio of 20-50:80-50, and 1-10 parts by weight of a modifier, wherein the ash content of the natural asphalt is as high as 60 wt % based on the weight of the natural asphalt, and trichloroethylene insoluble particles having a particle size of 10 microns or more in the asphalt binder are in a volume ratio of 5% or less.

### CROSS-REFERENCE TO RELATED APPLICATION

This is a continuation of International Patent Application No. PCT/CN2021/077523 filed on Feb. 23, 2021. The disclosure of the above-referenced application is hereby incorporated by reference in its entirety.

### BACKGROUND

A high-modulus asphalt mixture is a high-quality asphalt mixture originating from France, which simultaneously meets the two conditions of the modulus (15° C., 10 Hz) not less than 14,000 MPa and the fatigue life (10° C., 25 Hz, 130 με) greater than one million times to be called the high-modulus asphalt mixture. Because of its good high-temperature deformation resistance, durability and strong load-carrying capacity, the high-modulus asphalt mixture has been widely used abroad. With the development of economy, the demand for high-quality engineering construction in the engineering field of China is increasingly strong. The high-modulus asphalt mixture, which is a building material with high performance and low life-cycle cost, has attracted the attention of many domestic construction parties, and will be included in the latest edition of the industry standard “Technical Specification for Construction of Highway Asphalt Pavements” (JTG F40) as a construction material of high-grade pavements.

However, the low-temperature crack resistance of the high-modulus asphalt mixture is insufficient, which is the main problem restricting its wide application in China. Chinese standard specifications, “Technical Guide for Construction of High Modulus Asphalt Pavement Mixture” (T/CHTS 10004-2018) and “Durable High Modulus Asphalt Mixture for Road Engineering” (GB/T36143-2018) require that the low-temperature bending failure strain of the high-modulus asphalt mixture at −10° C. should not be less than 2000 με. This will make the high-modulus asphalt mixture unable to be applied in winter cold regions of China. That is, it is difficult to use the high-modulus asphalt mixture in the vast western, northwestern and northern regions of China.

Therefore, road construction in cold regions, such as the vast western region of China, still needs an asphalt mixture with low temperature resistance and high modulus.

### SUMMARY

The disclosure relates to the field of pavement materials, in particular to a high-modulus asphalt binder and mixture, and a preparation method for the high-modulus asphalt binder.

The purpose of the disclosure is to provide a high-modulus asphalt binder and mixture, especially suitable for cold regions with both high modulus and low temperature performance and a preparation method for the high-modulus asphalt binder.

In view of this, the first aspect of the disclosure provides a high modulus asphalt binder, which includes: 100 parts by weight of an asphalt and 1-10 parts by weight of a modifier.

The asphalt consists of a natural asphalt and a petroleum asphalt in a weight ratio of 20-50:80-50.

An ash content of the natural asphalt is up to 60 wt % based on a weight of the natural asphalt, and trichloroethylene-insoluble-substances having a particle size of 10 microns or more in the asphalt binder are in a volume ratio of 5% or less.

The second aspect of the disclosure provides a high modulus asphalt mixture, which includes 5-10 wt %, preferably 5-6.5 wt %, of the asphalt binder of the first aspect of the disclosure.

The third aspect of the disclosure provides a preparation method for the high-modulus asphalt binder of the first aspect of the disclosure. The method includes the following operations.

The natural asphalt is crushed to 300-1000 mesh and then mixed with total amount of a molten petroleum asphalt or 25-50% of the molten petroleum asphalt to form an asphalt blend.

The asphalt blend is ground when a temperature of the asphalt blend raises to 160° C. to 180° C.

The modifier or a modified asphalt is added to the ground asphalt blend to obtain the high modulus asphalt binder.

The modified asphalt is obtained by blending a remaining 50-75% of the petroleum asphalt as matrix with the modifier.

### BRIEF DESCRIPTION OF THE DRAWINGS

FIG. 1 shows a particle size distribution diagram of trichloroethylene insoluble particles in the binder prepared in Example 1.

FIG. 2 shows a particle size distribution diagram of trichloroethylene insoluble particles in the binder prepared in Example 2.

FIG. 3 shows a particle size distribution diagram of trichloroethylene insoluble particles in the binder prepared in Example 3.

FIG. 4 shows a particle size distribution diagram of trichloroethylene insoluble particles in the binder prepared in Example 4.

FIG. 5 shows a particle size distribution diagram of trichloroethylene insoluble particles in the binder prepared in Example 5.

FIG. 6 shows a particle size distribution diagram of trichloroethylene insoluble particles in the binder prepared in Comparative Example 1.

### DETAILED DESCRIPTION

As used herein, the terms “comprise/include” “contain,” or any other variation thereof are intended to cover non-exclusive inclusion, so that a method or a composition including a series of elements includes not only the explicitly stated elements, but also other elements not explicitly listed, or elements inherent to the implementation of the method or the composition. In the absence of further limitations, an element defined by the phrase “include a/an . . . ” does not exclude the existence of other related elements in the method or composition including the element.

As used herein, the term “consist/be composed of” means that the method or the composition contains only the stated elements, i.e. it contains no other elements except the stated elements.

The elements are, for example, operations of the method, or components of the composition, etc.

The “% (percentage)” in the asphalt binder and mixture referred to in the context means, unless otherwise specified, percentage by weight.

Chinese patent CN104194366 discloses a modifier for low-temperature resistant high-modulus composite asphalt and a method for preparing the modifier. As an additive, the modifier needs to be added into asphalt before use. Although the index of the low-temperature crack resistance of the mixture is good, no specific value of modulus of the mixture is mentioned in the examples, only the dynamic stability is involved. Therefore, its high-modulus characteristics need to be verified. In addition, because the modifier includes complex components (low-temperature resistant and high-modulus main agent, reinforcing binder and isolation agent), there are many steps in the preparation process and the material cost is high.

At present, most of the high-modulus asphalt mixtures in China need to use high-modulus agent. For example, high-modulus agent such as PRS and PRM from France, Lubao from China and Duroflex from Germany are commonly used. However, the low-temperature crack resistance of the high-modulus asphalt mixtures obtained is insufficient.

The disclosure provides a high modulus asphalt binder, which includes: 100 parts by weight of an asphalt and 1-10 parts by weight of a modifier.

The asphalt consists of a natural asphalt and a petroleum asphalt in a weight ratio of 20-50:80-50.

An ash content of the natural asphalt is up to 60 wt % based on a weight of the natural asphalt, and trichloroethylene-insoluble-substances having a particle size of 10 microns or more in the asphalt binder are in a volume ratio of 5% or less.

According to an embodiment, the ash content of the natural asphalt is up to 50 wt % based on the weight of the natural asphalt, and the trichloroethylene-insoluble-substances having a particle size of 10 microns or more in the asphalt binder are in a volume ratio of 3% or less.

According to an embodiment, an amount of the modifier is 3-8 parts by weight.

The natural asphalt is selected from one or more of Iranian rock asphalt, Buton rock asphalt, Trinidad lake asphalt or China Qingchuan rock asphalt. The petroleum asphalt is selected from one or more of petroleum asphalt 50 #, petroleum asphalt 70 #, petroleum asphalt 90 # or petroleum asphalt 110 #.

The modifier is selected from one or more of rubber powder, SBS or SBR. Preferably, the modifier contains 1-5 parts by weight, preferably 3-5 parts by weight of SBS and/or SBR; alternatively, the modifier contains 3-8 parts by weight, preferably 5-8 parts by weight of the rubber powder.

According to an embodiment, the asphalt binder further includes 0.5-4 parts by weight of rubber oil, preferably 0.5-1.5 parts by weight of the rubber oil.

The rubber oil used in the disclosure is not particularly limited, in which aromatic rubber oil is preferred.

According to an embodiment, the trichloroethylene-insoluble-substances in the asphalt binder have an average particle size of 3-5 m, preferably 3.5-4.5 m.

Preferably, the high-modulus asphalt binder of the disclosure consists of 100 parts by weight of the asphalt and 1-10 parts by weight of the modifier. The asphalt consists of the natural asphalt and the petroleum asphalt in the weight ratio of 20-50:80-50. The ash content of the natural asphalt is up to 60 wt %, preferably up to 50 wt %, based on the weight of the natural asphalt, and the trichloroethylene-insoluble-substances having a particle size of 10 microns or more in the asphalt binder are in a volume ratio of 5% or less, preferably 3% or less.

The disclosure further provides a high modulus asphalt mixture, which includes 5-10 wt %, preferably 5-6.5 wt %, of the asphalt binder of the first aspect of the disclosure.

The disclosure further provides a preparation method for the high-modulus asphalt binder of the first aspect of the disclosure. The method includes the following operations.

The natural asphalt is crushed to 300-1000 mesh and then mixed with total amount of a molten petroleum asphalt or 25-50% of the molten petroleum asphalt to form an asphalt blend.

The asphalt blend is ground when a temperature of the asphalt blend raises to 160° C. to 180° C.

The modifier or a modified asphalt is added to the ground asphalt blend to obtain the high modulus asphalt binder.

The modified asphalt is obtained by blending a remaining 50-75% of the petroleum asphalt as matrix with the modifier.

In the disclosure, the volume ratio of mineral particles with a particle size of m or more in the natural asphalt is reduced effectively by grinding the natural asphalt at an elevated temperature, so that characteristics of the natural asphalt can be better utilized, and the asphalt binder with both high-modulus and low temperature performance can be obtained by cooperating with the polymer modifier.

In addition, according to the method of the disclosure, the mineral particles of the natural asphalt can be stably suspended without the need for additional stabilizers to form a network stabilizing structure in the asphalt system, thus avoiding undesired performances caused by adding the stabilizers, further expanding the application of the natural asphalt, and expanding the available natural asphalt varieties.

In the preparation of the asphalt binder of the disclosure, grinding is performed at a further elevated temperature (160° C. to 180° C., preferably 170° C. to 180° C.), thus obtaining an abnormal distribution of the particle size of trichloroethylene insoluble particles. That is to say, the average particle size of mineral particles in the ground asphalt is still in a range of 3-5 m, but the particle size distribution accords with a negatively skewed distribution. The volume ratio of particles with a particle size of 10 microns or more is 5% or less, particularly 3% or less, and even 1.5% or less. Therefore, same storage stability is obtained without using particle dispersion stabilizers, and the influence of the particle dispersion stabilizers on performance of asphalt products is avoided, and a low temperature modification effect of a polymer modifier is exerted.

Accordingly, in the preparation method of the asphalt binder of the disclosure, the natural asphalt is crushed to 300-1000 mesh and then mixed with a molten petroleum asphalt to form the asphalt blend. The asphalt blend is ground when a temperature of the asphalt blend raises to 160-180° C. Finally, a modifier or a modified asphalt is added into the ground asphalt blend.

Before grinding, the crushed natural asphalt and the molten petroleum asphalt are mixed well, and then the temperature of the blend is raised to 160-180° C., especially 170-180° C., and then the grinding is performed.

The grinding may be performed by a ball grinding mill. The grinding time varies according to the types of the natural asphalt and the petroleum asphalt used, the mixing ratio and the grinding temperature.

Particle size analysis may be used to check whether the required average particle size and the volume ratio of particles with a particle size of 10 microns or more are achieved.

The natural asphalt may be first mixed with part of the petroleum asphalt for grinding to obtain a natural asphalt mother liquor. The natural asphalt mother liquor may be mixed with the petroleum asphalt modified by the modifier. The part of the petroleum asphalt for preparing the natural asphalt mother liquor may be of 25-50%, preferably 25-40%, of the total weight of the petroleum asphalt in the final binder.

In a method of using the natural asphalt mother liquor, the modifier and the remaining petroleum asphalt may be blended in advance to prepare the modified asphalt for later use, so as to save time for preparing the binder.

The modified asphalt may be prepared by any suitable conventional method. For example, a polymer-modified asphalt may be prepared by operations of swelling, shearing, dispersion, development and the like.

Alternatively, in another embodiment, the natural asphalt and all the petroleum asphalt are mixed and then ground, and then the polymer modifier is added for shearing, dispersion and development. The method makes it easier to obtain the required average particle size, and can further simplify the preparation for the binder.

The natural asphalt used in the disclosure is not particularly limited. When performing the method of the disclosure, both lake asphalt and rock asphalt may be used. For example, the natural asphalt that may be used in the disclosure may be Iranian rock asphalt, Buton rock asphalt, Trinidad lake asphalt, China Qingchuan rock asphalt, or any combination thereof, but not limited thereto.

According to the method of the disclosure, the natural asphalt with an ash content of up to 60 wt %, preferably of 50 wt %, may be used. Therefore, at present, natural asphalt from most origin may be used in the disclosure.

The ash content of a natural asphalt indirectly indicates an effective asphalt content in the natural asphalt. When the natural asphalt has high ash content, processing is difficult, it has high risk of precipitation and segregation, but its price is low. For example, Iranian rock asphalt usually has an ash content of 10%-30%. Buton rock asphalt usually has an ash content of about 45-50%, which has low price. Trinidad lake asphalt usually has an ash content of about 30%, the price of which is 5-7 times that of Buton rock asphalt. Therefore, the method of the disclosure can also reduce the cost to a certain extent.

Generally, it is more advantageous to grind the mineral (trichloroethylene-insoluble-substances) particles in the natural asphalt as fine as possible. For example, in the disclosure, the trichloroethylene-insoluble-substances after grinding have an average particle size of 3-5 m, preferably 3.5-4.5 m. The average particle size of the trichloroethylene-insoluble-substances within the above range is beneficial for the mineral particles to suspend stably in the molten asphalt.

The applicant found by research, although the average particle size of the trichloroethylene-insoluble-substances may be further reduced by prolonging grinding time, the prolonged grinding time has adverse effects on the overall performance of the asphalt binder, especially the ductility. When the grinding time is prolonged, the particle sizes of the trichloroethylene-insoluble-substances decrease, and meanwhile some indexes such as the softening point and the ductility of the asphalt decay will decreased. In the further research, the applicant found that when the natural asphalt and the molten petroleum asphalt were mixed well and then ground at the elevated temperature, a negatively skewed distribution of the particle sizes of trichloroethylene-insoluble-substances was obtained. Different from the normal distribution of particle sizes obtained conventionally, the ratio of particles with larger particle sizes obtained by the method of the disclosure is extremely small. Specifically, the ratio of particles with a particle size of 10 microns or more may be 5% or less, preferably 3% or less, and more preferably 1.5% or less, thereby obtaining the asphalt blend with significantly improved stability of the natural asphalt. Therefore, the obtained asphalt blend of the disclosure can be stably stored for a long time without segregation in the absence of additional additives for stabilizing particles. Therefore, a relative content of the natural asphalt in the disclosure may also be in the range of the weight ratio of the natural asphalt to the petroleum asphalt of 20-50:80-50. According to the specific needs, a higher amount of the natural asphalt may be chosen.

The natural asphalt may be crushed to 300 to 1000 mesh in advance to facilitate mixing with the petroleum asphalt.

The natural asphalt has excellent high temperature performance, aging resistance, weathering resistance, water damage resistance and other excellent performances. By adding the natural asphalt of the above range, the asphalt binder and mixture obtained in the disclosure have achieved satisfactory road performance, and the complex modulus and fatigue life are far higher than the specified technical indexes.

The petroleum asphalt that may be used in the disclosure is not particularly limited, and an appropriate brand may be selected as needed. For example, one or more of petroleum asphalt 50 #, petroleum asphalt 70 #, petroleum asphalt 90 # and petroleum asphalt 110 # may be selected.

As mentioned above, the modifier may be directly added to the ground asphalt blend. Alternatively, the modifier may be blended with the petroleum asphalt as the matrix asphalt in advance to obtain the modified asphalt, and then the modified asphalt is added to the ground asphalt blend.

A modifier that may be used in the disclosure may be a polymer modifier, such as thermoplastic elastomer, rubber powder, or the like. For example, it may be rubber powder, SBS, SBR or a combination thereof Δn additive amount of the polymer modifier may be determined according to the needs and the specific type of modifier used, and usually may be in a range of 1-10 parts by weight based on 100 parts by weight of the asphalt.

When SBS and/or SBR is used as the modifier, the amount may be in a range of 1-5 parts by weight, preferably 3-5 parts by weight, based on 100 parts by weight of the asphalt. Alternatively, the modifier used in the disclosure may be only rubber powder. The amount of the rubber powder may be in the range of 3-8 parts by weight, preferably 5-8 parts by weight, based on 100 parts by weight of the asphalt.

According to another embodiment, the modifier may be added to the petroleum asphalt to prepare a modified asphalt. For example, the petroleum asphalt as matrix in the modified asphalt may be 50-75% of the total petroleum asphalt in the final asphalt binder.

In order to further improve the modification effect of the modifier or the modified asphalt, rubber oil is added before adding the modifier or the modified asphalt.

According to one embodiment, 0.5-4 parts by weight, preferably 0.5-1.5 parts by weight of rubber oil, is added after grinding the asphalt blend and before adding the modifier or the modified asphalt.

The rubber oil of the disclosure is not particularly limited. For example, it may be selected from aromatic rubber oil. The added rubber oil improves the compatibility between the polymer modifier, such as SBS, and the asphalt. The molecular weight of SBS is usually hundreds of thousands, while the molecular weight of the asphalt is only thousands, so that SBS and the asphalt have poor mutual compatibility and are easy to segregate. After adding the rubber oil, aromatic phenols, the main component of the rubber oil, easily enter SBS, which helps SBS to be compatible with the asphalt, thus improving the effect of the polymer modifier.

In addition, without being limited by an existing theory, it is speculated that the further decrease of the volume ratio of the mineral particles with large sizes (such as 10 microns or more) in the disclosure is also helpful to reduce the adverse effect of stress concentration caused by the large-sized mineral particles in the asphalt on low-temperature performance, and has a positive effect on the stability of the system.

The above improvements of the disclosure give full play to the improvement of the low temperature performance of the asphalt mixture by the polymer modifier, and reduce the adverse effect of the natural asphalt on the low-temperature performance, so that the low-temperature bending failure strain is higher than the specified standard. Therefore, the asphalt product with both high modulus and low-temperature performance is obtained, and the asphalt binder and mixture that meet the technical requirements and have excellent weathering resistance and service life for road construction in severe cold regions are provided.

A clear and complete description of the technical solution of the disclosure will be given below in conjunction with examples of the disclosure. It is apparent that the described embodiments are only part of and not all of the embodiments of the disclosure. Based on the embodiments in the disclosure, any other embodiment obtained by those skilled in the art without creative work falls within the protection scope of the disclosure.

Test Methods:

Particle size and particle size distribution are measured by winner 2000E laser particle size analyzer produced by Jinan Winner Particle Instrument Co., Ltd.

Other indexes, such as penetration degree and softening point, are measured according to “Standard Test Methods of Bitumen and Bituminous Mixtures for Highway Engineering” (JTG E20-2011).

Dynamic stability and low-temperature bending failure strain are measured according to “Standard Test Methods of Bitumen and Bituminous Mixtures for Highway Engineering” (JTG E20-2011).

Complex modulus (15° C., 10 Hz) and fatigue life (10° C., 25 Hz, 130 με) are measured according to EN 12697-26 and EN 12697-24 in “EN12697 Series Standards” of European bituminous mixtures test methods.

### Example 1: Preparation of Asphalt Binder 1

20 kg of Buton rock asphalt (with an ash content of about 50%) and 3 kg of Iranian rock asphalt (with an ash content of about 9%) were crushed to about 300 mesh, and then added into 22 kg of SK-90 asphalt which had been heated to 140° C. to form a blend. The blend was stirred, then heated to 170° C., and ground with a ball grinding mill at the temperature. Then 58 kg of modified asphalt, which contained 54.5 kg of SK-90 asphalt and 3 kg of SBS (C411 of DYNASOL, USA), and 0.5 kg of rubber oil were added into the blend. The blend was stirred evenly at 180° C. to obtain an asphalt binder.

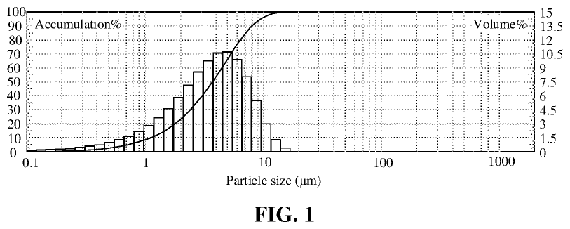

In the obtained asphalt binder, the trichloroethylene-insoluble-substances having a particle size of 10 microns or more was in a volume ratio of about 4%, the average particle size was 4.2 μm (referring to the particle size distribution diagram shown in FIG. 1), and the penetration was in a range of 25-40 dmm.

### Example 2: Preparation of Asphalt Binder 2

20 kg of Buton rock asphalt (with an ash content of about 50%) and 3 kg of Iranian rock asphalt (with an ash content of about 9%) were crushed to about 300 mesh, and then added into 77 kg of SK-90 asphalt which had been heated to 140° C. to form a blend. The blend was stirred, then heated to 165° C., and ground with a ball grinding mill at the temperature. 0.5 kg of rubber oil and 3 kg of SBS (C411 of DYNASOL, USA) were added into the blend. The blend was stirred at 180° C. evenly, and fully sheared by colloid mill, and then developed at 180° C. for 2 hours to obtain an asphalt binder.

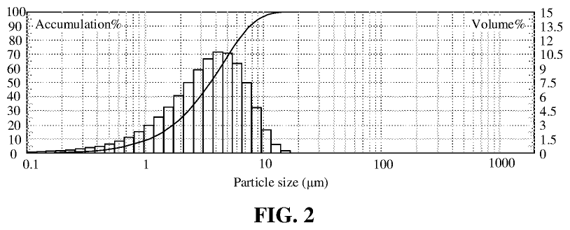

In the obtained asphalt binder, the trichloroethylene-insoluble-substances having a particle size of 10 microns or more was in a volume ratio of about 3%, the average particle size was 4.0 μm (referring to the particle size distribution diagram shown in FIG. 2), and the penetration degree was in a range of 25-40 dmm.

### Example 3: Preparation of Asphalt Binder 3

35 kg of Buton rock asphalt (with an ash content of about 50%) was crushed to about 300 mesh, and then added into 65 kg of SK-90 asphalt which had been heated to 140° C. to form a blend. The blend was stirred, then heated to 175° C., and ground at the temperature. 0.75 kg of rubber oil and 4 kg of SBS (C411 of DYNASOL, USA) were added into the blend and stirred at 180° C. evenly and fully sheared by colloid mill, and then developed at 180° C. for 2 hours to obtain an asphalt binder.

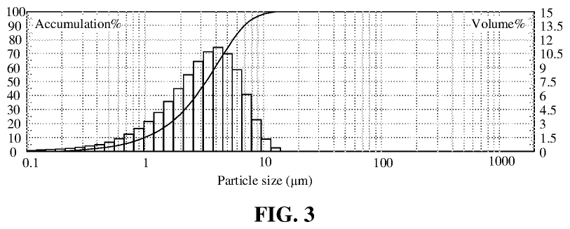

In the obtained asphalt binder, the trichloroethylene-insoluble-substances having a particle size of 10 microns or more was in a volume ratio of about 1.5%, the average particle size was 3.7 μm (referring to the particle size distribution diagram shown in FIG. 3), and the penetration degree was in a range of 25-40 dmm.

### Example 4: Preparation of Asphalt Binder 4

25 kg of Trinidad lake asphalt (with an ash content of about 35%) was crushed to 300 mesh, and then added into 75 kg of SK-90 asphalt which had been heated to 140° C. to form a blend. The blend was stirred, then heated to 165° C., and ground at the temperature. 0.5 kg of rubber oil and 4 kg of SBR (SBR products of Shandong Gaoshike Industry and Trade Co., Ltd.) were added into the blend and stirred at 180° C. evenly, sheared fully by colloid mill, and then developed at 180° C. for 2 hours to obtain an asphalt binder.

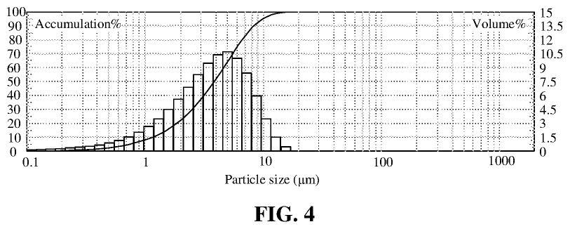

In the obtained asphalt binder, the trichloroethylene-insoluble-substances having a particle size of 10 microns or more was in a volume ratio of about 4.5%, the average particle size was 4.4 μm (referring to the particle size distribution diagram shown in FIG. 4), and the penetration degree was in a range of 25-40 dmm.

### Example 5: Preparation of Asphalt Binder 5

40 kg of Buton rock asphalt (with an ash content of about 50%) was crushed to about 300 mesh, and then added into 60 kg of SK-90 asphalt which had been heated to 140° C. to form a blend. The blend was stirred, then heated to 175° C., and ground at the temperature. 1.5 kg of rubber oil and 8 kg of 40 mesh rubber powder particles were added into the blend and stirred at 190° C. evenly, and then fully sheared by colloid mill to obtain an asphalt binder.

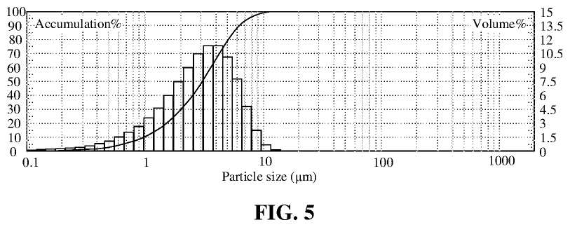

In the obtained asphalt binder, the trichloroethylene-insoluble-substances having a particle size of 10 microns or more was in a volume ratio of about 0.5%, the average particle size was 3.4 μm (referring to the particle size distribution diagram shown in FIG. 5), and the penetration degree was in a range of 25-40 dmm.

### Comparative Example 1

35 kg of Buton rock asphalt (with an ash content of about 50%) was crushed to about 300 mesh, and then mixed with 65 kg of SK-90 asphalt which had been heated to 140° C. to form a blend. The blend was ground, and then 0.5 kg of silane coupling agent and 4 kg of SBS (C411 of DYNASOL, USA) were added into the blend and then were sheared. 0.12 kg of sulfur was added into the blend. The blend was developed for 3 hours, and then 0.1 kg of sasobit (SasolWax, Germany) was added into the blend and stirred for half an hour to obtain an asphalt binder.

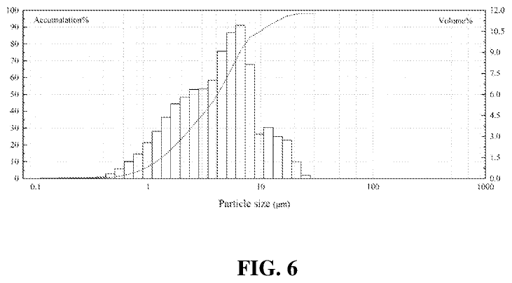

In the obtained asphalt binder, the trichloroethylene-insoluble-substances having a particle size of 10 microns or more was in a volume ratio of about 13%, and the average particle size was 4.8 μm (referring to the particle size distribution diagram shown in FIG. 6).

### Comparative Example 2

100 kg of SBS modified asphalt, which takes SK-90 as matrix asphalt and has an SBS content of 3.85% of the weight of the modified asphalt, was heated to 180° C. in a flowable state, and then 10 kg of French PR additive (PR additive of PR Company, French) was added into the modified asphalt. After swelling and developing for 15 min, high-speed shearing was performed until all particles of the additives cannot be observed.

### Comparative Example 3

25 kg of Trinidad lake asphalt (with an ash content of about 35%) of about 300 mesh was added into 79.75 kg of SBS modified asphalt which had been heated to 180° C. and stirred to obtain an asphalt binder with penetration degree in a range of 25-40 dmm. The modified asphalt contained 75 kg of SK-90 as the matrix asphalt, 4 kg of SBS (C411 of DYNASOL, USA) and 0.75 kg of rubber oil.

### Comparative Example 4

35 kg of Buton rock asphalt (with an ash content of about 50%) was crushed to about 300 mesh, and then added into 69.75 kg of SBS modified asphalt which had been heated to 180° C. and stirred to obtain an asphalt binder with penetration degree in a range of 25-40 dmm. The modified asphalt contained 65 kg of SK-90 as the matrix asphalt, 4 kg of SBS (C411 of DYNASOL, USA) and 0.75 kg of rubber oil.

Performance Test Results of the Binders:

The performance test results of the asphalt binders prepared in the above examples and comparative examples are shown in Table 1:

TABLE 1
the test results of the asphalt binders prepared in the above Examples and Comparative Examples

| | | | | | | | Compar- | Compar- | Compar- | Compar- | |
|---|---|---|---|---|---|---|---|---|---|---|---|
| | | | | | | | ative | ative | ative | ative | Test |
| Test item | Unit | Example 1 | Example 2 | Example 3 | Example 4 | Example 5 | Example 1 | Example 2 | Example 3 | Example 4 | method |
| Average particle | μm | 4.2 | 4.0 | 3.7 | 4.4 | 3.4 | 4.8 | — | — | — | Laser |
| size Insolubles | | | | | | | | | | | particle |
| Insolubles D₉₀ | μm | 8.1 | 7.7 | 7.0 | 8.5 | 6.3 | 12.0 | — | — | — | size |
| Insolubles D₁₀ | μm | 1.1 | 1.1 | 1.0 | 1.1 | 1.0 | 1.0 | — | — | — | analyzer |
| Volume percentage | % | 4% | 3% | 1.5% | 4.5% | 0.5% | 13% | — | — | — | |
| of insolubles | | | | | | | | | | | |
| with particle | | | | | | | | | | | |
| size of 10 μm | | | | | | | | | | | |
| or more | | | | | | | | | | | |
| Penetration | 0.1 mm | 34 | 37 | 30 | 36 | 32 | 35 | 32 | 38 | 35 | T0604 |
| degree(25° C., | | | | | | | | | | | |
| 100 g, 5 s) | | | | | | | | | | | |
| Softening point | ° C. | 71 | 72 | 75 | 66 | 62 | 70 | 88 | 75 | 72 | T0606 |
| Ductility | cm | 85 | 86 | 88 | 96 | 81 | 82 | 10 | 67 | 5 | T0605 |
| (25° C., 5 cm/min) | | | | | | | | | | | |
| Flash point | ° C. | 298 | 302 | 313 | 287 | 310 | 303 | 299 | 320 | 278 | T0611 |
| Viscosity (175° C.) | Pa · s | 0.62 | 0.69 | 0.79 | 0.57 | 1.22 | 0.55 | 0.52 | 2.34 | Unable to | T0625 |
| | | | | | | | | | | determine | |
| Elastic restitution | % | 84 | 87 | 88 | 90 | 67 | 70 | Unable to | 80 | Unable to | T0662 |
| (25° C.) | | | | | | | | determine | | determine | |
| Storage stability, | ° C. | 1.2 | 1.3 | 1.5 | 1.8 | 1.8 | 1.6 | 0.8 | Severely | Severely | T0661 |
| softening point | | | | | | | | | segregate | segregate | |
| difference after | | | | | | | | | | | |
| 48 h segregation | | | | | | | | | | | |
| Residues after TFOT or RTFOT | | | | | | | | | | | T0609 |
| Quality change | % | −0.1 | −0.4 | −0.15 | 0.2 | −0.25 | −0.3 | 0.88 | 0.2 | −0.6 | T0610 |
| Residual | % | 80 | 83 | 78 | 81 | 78 | 85 | 75 | 90 | 66 | T0604 |
| penetration | | | | | | | | | | | |
| ratio | | | | | | | | | | | |

### Examples 6-8: Preparation of Asphalt Mixtures

The gradations were configured according to Tables 2 and 3 below, and the following asphalt mixtures were prepared respectively.

According to Gradation 3, the asphalt mixture of Example 6 was prepared with the asphalt binder of Example 1 at an asphalt-stone ratio of 5.8%.

According to Gradation 1, the asphalt mixture of Example 7 was prepared with the asphalt binder of Example 3 at an asphalt-stone ratio of 5.8%.

According to Gradation 2, the asphalt mixture of Example 8 was prepared with the asphalt binder of Example 3 at an asphalt-stone ratio of 5.8%.

TABLE 2
Gradation range of the high-modulus asphalt mixtures

| Type of | Weight percentage (%) through the following sieve holes (mm) | | | | | | | |
|---|---|---|---|---|---|---|---|---|
| mixture | 26.5 | 19 | 16 | 13.2 | 9.5 | 4.75 | 2.36 | 0.075 |
| BBME-13 | — | — | 100 | 90-100 | — | 39-60 | 28-43 | 6.4-7.3 |
| BBME-16 | — | 100 | 90-100 | — | — | 40-52 | 26-38 | 6.4-7.3 |
| EME-13 | — | — | 100 | 90-100 | 62-81 | — | 30-42 | 5.5-8.0 |
| EME-16 | — | 100 | 90-100 | — | 66-84 | 42-64 | 27-42 | 5.5-8.0 |
| EME-20 | 100 | 90-100 | — | — | 66-84 | 42-64 | 27-42 | 5.5-8.0 |

TABLE 3
Gradations of the high-modulus asphalt mixtures

| Type of | Weight percentage (%) through the following sieve hole size (mm) | | | | | | | | | | | |
|---|---|---|---|---|---|---|---|---|---|---|---|---|
| mixture | 26.5 | 19 | 16 | 13.2 | 9.5 | 4.75 | 2.36 | 1.18 | 0.6 | 0.3 | 0.15 | 0.075 |
| Gradation 1 | — | 100 | 100 | 98.3 | 80.3 | 50.2 | 32.3 | 24.3 | 18.5 | 13.4 | 9.6 | 6.9 |
| (BBME-13) | | | | | | | | | | | | |
| Gradation 2 | — | 100 | 96.5 | 88.4 | 73 | 49.1 | 29.1 | 21.8 | 16.7 | 12.1 | 8.7 | 6.3 |
| (EME-16) | | | | | | | | | | | | |
| Gradation 3 | 100.0 | 100 | 91 | 84 | 75 | 49 | 29.0 | 23.0 | 17.0 | 12.8 | 10.0 | 7.0 |
| (EME-20) | | | | | | | | | | | | |

Aggregate quality should meet the requirements of the current industry standard “Technical Specification for Construction of Highway Asphalt Pavements” (JTG F40). A process for preparing the above mixtures was as follows.

The aggregate was heated to 190° C., and then dry-mixed for 40 seconds in a mixing pot (the temperature was set at 185° C.). An asphalt which has been heated to 185° C. was added into the mixing pot at a certain asphalt-stone ratio, and then stirred for 90 seconds. Mineral powder was then poured into the mixing pot, and stirred for 90 seconds until there is no white material, thus obtaining the mixture.

### Comparative Examples 5-8: Preparation of Asphalt Mixtures

According to Gradation 2 of Table 3, the asphalt mixture of Comparative Example 5 was prepared with the asphalt binder of Comparative example 1 at an asphalt-stone ratio of 5.8%.

According to Gradation 2 of Table 3, the asphalt mixture of Comparative Example 6 was prepared with the asphalt binder of Comparative example 2 at an asphalt-stone ratio of 5.8%.

According to Gradation 2 of Table 3, the asphalt mixture of Comparative Example 7 was prepared with the asphalt binder of Comparative example 4 at an asphalt-stone ratio of 5.8%.

Performance Test Results of the Mixtures:

Dynamic stability (60° C.), low-temperature bending failure strain (−10° C.), complex modulus (15° C., 10 Hz) and fatigue life (10° C., 25 Hz, 130 με) of each of the asphalt mixtures of Examples 6-8 and Comparative Examples 5-7 were measured.

Test results were shown in Table 4 below for details.

TABLE 4

| | | Technical | | | | | | | Experiment |
|---|---|---|---|---|---|---|---|---|---|
| Test item | Unit | requirements | Ex. 6 | Ex. 7 | Ex. 8 | C. E. 5 | C. E. 6 | C. E. 7 | Method |
| Dynamic stability | Times/mm | ≥5000 | 6732 | 5235 | 5191 | 6352 | 5670 | 4475 | T0719 |
| low-temperature | με | ≥2800 | 3210 | 3168 | 3301 | 2460 | 2360 | 2140 | T0715 |
| bending failure | | | | | | | | | |
| strain | | | | | | | | | |
| Complex modulus | MPa | ≥14000 | 19883 | 20044 | 18056 | 17079 | 14225 | 12455 | EN12697-26 |
| Fatigue life | ten thousand | ≥100 | 148 | 158 | 164 | 182 | 87 | 142 | EN12697-24 |
| | times | | | | | | | | |

Data of the comparative examples shows that application of a conventional high-modulus additive (Comparative Example 6) has problems of fatigue and insufficient low-temperature crack resistance. Moreover, after adding natural asphalt and SBS for composite modification according to a traditional method (Comparative Example 7), the low-temperature crack resistance and modulus value are difficult to meet the technical requirements of the high-modulus asphalt mixture.

All indexes of each of the asphalt mixtures prepared according to the method of the disclosure meet the technical requirements.

The description above is only preferred embodiments of the disclosure, and is not intended to limit the protection scope of the disclosure. Any equivalent structural transformation made by using the contents of the specification and drawings of the disclosure, or direct/indirect application in other related technical fields, within the conception of the disclosure, falls within the protection scope of the disclosure.

1. A high modulus asphalt binder, comprising:
100 parts by weight of an asphalt consisting of an natural asphalt and a petroleum asphalt in a weight ratio of 20-50:80-50; and
1-10 parts by weight of a modifier, wherein,
an ash content of the natural asphalt is up to 60 wt % based on a weight of the natural asphalt, and trichloroethylene-insoluble-substances having a particle size of 10 microns or more in the asphalt binder are in a volume ratio of 5% or less.

2. The asphalt binder of claim 1, wherein the ash content of the natural asphalt is up to 50 wt % based on the weight of the natural asphalt, and the trichloroethylene-insoluble-substances having the particle size of 10 microns or more in the asphalt binder are in a volume ratio of 3% or less.

3. The asphalt binder of claim 1, wherein the asphalt consists of the natural asphalt and the petroleum asphalt in the weight ratio of 20-40: 80-60.

4. The asphalt binder of claim 1, wherein an amount of the modifier is 3-8 parts by weight.

5. The asphalt binder of claim 1, wherein the natural asphalt is selected from one or more of Iranian rock asphalt, Buton rock asphalt, Trinidad lake asphalt or China Qingchuan rock asphalt, and the petroleum asphalt is selected from one or more of petroleum asphalt 50 #, petroleum asphalt 70 #, petroleum asphalt 90 # or petroleum asphalt 110 #.

6. The asphalt binder of claim 1, wherein the modifier is selected from one or more of rubber powder, SBS or SBR; preferably, the modifier contains 1-5 parts by weight, more preferably 3-5 parts by weight of SBS and/or SBR; or preferably, the modifier contains 3-8 parts by weight, more preferably 5-8 parts by weight of the rubber powder.

7. The asphalt binder of claim 1, further comprising 0.5-4 parts by weight, preferably 0.5-1.5 parts by weight of rubber oil.

8. The asphalt binder of claim 1, wherein the petroleum asphalt in the asphalt binder has an average particle size of 3-5 m, preferably 3.5-4.5 m.

9. A high modulus asphalt mixture, comprising 5-10 wt % of an asphalt binder, wherein the asphalt binder comprises:
100 parts by weight of an asphalt consisting of an natural asphalt and a petroleum asphalt in a weight ratio of 20-50:80-50; and
1-10 parts by weight of a modifier, wherein,
an ash content of the natural asphalt is up to 60 wt % based on a weight of the natural asphalt, and trichloroethylene-insoluble-substances having a particle size of 10 microns or more in the asphalt binder are in a volume ratio of 5% or less.

10. The asphalt mixture of claim 9, comprising 5-6.5 wt % of the asphalt binder.

11. A preparation method for the high modulus asphalt binder of claim 1, comprising:
crushing the natural asphalt to 300-1000 mesh and mixing the natural asphalt with total amount of a molten petroleum asphalt or 25-50% of the molten petroleum asphalt to form an asphalt blend;
when a temperature of the asphalt blend raises to 160° C. to 180° C., grinding the asphalt blend; and
adding the modifier or a modified asphalt to the ground asphalt blend to obtain the high modulus asphalt binder, wherein
the modified asphalt is obtained by blending a remaining 50-75% of the petroleum asphalt as matrix with the modifier.

12. The method of claim 11, further comprising: adding rubber oil after grinding the asphalt blend.

13. The method of claim 11, wherein the grinding is performed by a ball grinding mill.

14. The method of claim 11, wherein a temperature of the molten petroleum asphalt is 130° C. to 140° C.

15. The method of claim 11, wherein the asphalt blend is mixed with the modifier or the modified asphalt at a further elevated temperature of 170° C. to 180° C.

16. The method of claim 11, wherein when a temperature of the asphalt blend raises to 170° C. to 180° C., the asphalt blend is ground.
